(19) United States
(12) Patent Application Publication
(10) Pub. No.: US 2009/0238743 A1
(43) Pub. Date: Sep. 24, 2009

(54) GOLD-SILVER NANOCATALYSTS AND PROCESSES FOR SYNTHESIZING THE SAME

(75) Inventors: Arvind Vyas Harinath, Greensboro, NC (US); Ramya Vedaiyan, Greensboro, NC (US); Chandra K. Banerjee, Clemmons, NC (US); Jagannathan Sankar, Greensboro, NC (US)

Correspondence Address: MYERS BIGEL SIBLEY & SAJOVEC, PO BOX 37428, RALEIGH, NC, 27627, US

(73) Assignee: North Carolina Agricultural and Technical State University

(21) Appl. No.: 12/240,403

(22) Filed: Sep. 29, 2008

Related U.S. Application Data
(60) Provisional application No. 60/976,066, filed on Sep. 28, 2007.

(51) Int. Cl. B01J 23/52; B01J 23/50; B01D 53/62

(52) U.S. Cl. 423/247; 502/347; 502/348

(57) ABSTRACT

The present invention provides catalysts including similar proportions of gold and silver on a granular support and processes for making the same. Methods of using the catalysts in processes requiring the oxidation of carbon dioxide are also provided.

### RELATED APPLICATION DATA

This application claims priority to and the benefit of U.S. Patent Application Ser. No. 60/976,066, filed Sep. 28, 2007, the disclosure of which is incorporated by reference herein in its entirety.

### FIELD OF THE INVENTION

The present invention generally concerns bimetallic nanocatalysts including gold and silver and processes for synthesizing the same.

### BACKGROUND OF THE INVENTION

It is known that carbon monoxide is a poisonous gas. It is present in the exhaust gas from automobiles as well as in cigarette smoke. Both the cigarette and automobile industries have tremendous interest in developing means to eliminate and/or reduce the carbon monoxide concentration in the environment. The ability of gold nanocatalysts to catalyze the oxidation of carbon monoxide to carbon dioxide at room temperature has been documented in the literature. However, gold is very expensive in today's market. A gold-silver nanocatalyst is currently used as a deodorizer and as an air purifier.

The present invention provides gold-silver nanocatalysts that can be used to effectively catalyze the oxidation of carbon monoxide to carbon dioxide. The gold-silver nanocatalysts can be used in a wide variety of applications including as catalysts for internal combustion engines, in gas masks, in fuel cells and carbon dioxide lasers, for example.

### SUMMARY OF THE INVENTION

An aspect of the present invention relates to catalysts including similar proportions of gold and silver.

Further aspects of the present invention relate to processes for the synthesis of gold-silver nanocatalysts including (a) mixing a solution of gold salt with a solution of silver salt; (b) adding a granular substrate to the mixture of (a); (c) adjusting the pH; (d) washing the product remaining after (c) with water; and (e) calcining the product resulting from (d).

Additional aspects of the present invention provide processes for the oxidation of carbon monoxide at room temperature including introducing a nanocatalyst including a similar proportion of gold and silver to an environment including carbon monoxide under conditions suitable to support the substantial conversion of carbon monoxide to carbon dioxide at room temperature.

The gold-silver nanocatalysts of the present invention may possess a fast reaction rate, high selectivity, and/or low reaction temperature. Additionally, the gold-silver nanocatalysts provided herein reflect a substantial cost savings compared to gold catalysts and demonstrate improved catalytic activity over catalysts manufactured of gold alone. Accordingly, the gold-silver nanocatalysts may be employed in a cost-effective and/or energy-efficient manner in the oxidation of carbon monoxide for applications including, but not limited to, internal combustion engines, gas masks, fuel cells and carbon dioxide lasers.

### DETAILED DESCRIPTION

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. As used herein, the term “and/or” includes any and all combinations of one or more of the associated listed items.

Unless otherwise defined, all technical and scientific terms used herein have the same meaning as commonly understood by one of ordinary skill in the art to which this invention belongs.

It will be understood that steps comprising the methods provided herein can be performed independently or at least two steps can be combined when the desired outcome can be obtained.

Embodiments of the present invention provide a catalyst comprising similar proportions of gold and silver on a granular support. Similar proportions can include an approximate 1:1 ratio and less than a 2:1 ratio of the metals. In some embodiments, the granular support comprises a metal oxide. The metal oxide can include, but is not limited to, aluminum oxide, silicon oxide, magnesium oxide, titanium oxide and combinations thereof. In particular embodiments, the metal oxide is aluminum oxide. In other embodiments, the particle size of the catalyst is less than about 10 nm. In some embodiments of the present invention, the catalysts include less than about 10% more gold than silver.

Embodiments of the present invention further provide a process for the synthesis of a catalyst comprising gold and silver. This process comprises (a) adding a granular substrate to the mixture of a solution of a gold salt with a solution of a silver salt; (b) adjusting the pH; (c) washing the product remaining after (b) with water, for example deionizing water; and (d) calcining the product resulting from (c). In some embodiments, the granular support comprises a metal oxide. The metal oxide can include, but is not limited to, aluminum oxide, silicon oxide, magnesium oxide, titanium oxide and combinations thereof. In particular embodiments, the metal oxide is aluminum oxide. In some embodiments, the pH is adjusted to 4.0. In some embodiments, the particle size of the catalyst is less than about 10 nm.

Embodiments of the present invention further provide a process for the oxidation of carbon monoxide at a room temperature comprising introducing a catalyst including a similar proportion of gold and silver to an environment including carbon monoxide under conditions suitable to support the substantial conversion of carbon monoxide to carbon dioxide at a room temperature. The catalysts are contemplated as having utility for applications including, but not limited to, internal combustion engines, gas masks, fuel cells and carbon dioxide lasers.

Embodiments of the present invention will be further explained with reference to the following example, which is included herein for illustration purposes only, and which is not intended to be limiting of the invention.

### Example

### Synthesis of Gold-Silver Nanocatalysts

Approximately 200 mg each of gold tetrachloroaurate (HAuCl₄) and silver nitrate (AgNO₃) was dissolved separately in 100 ml of deionized (DI) water. The two solutions were mixed in a beaker. The pH of the resulting mixture was 2.97. About 5 g of aluminum oxide was added to the mixture. Addition of aluminum oxide raised the pH to 3.02. The solution containing the mixture and aluminum oxide was stirred vigorously until the pH of the mixture reached 4.0, which required mixing for approximately 30 minutes. The increase in pH from 3.02 to 4.0 represented the migration of gold and silver ions to the surface of the aluminum oxide substrate, and accordingly, the aluminum oxide particles were coated with gold and silver ions. The coated aluminum oxide particles were recovered by filtration and washed with excess DI water to remove nitrate and chlorine ions.

About 5 ml of 0.0175M ammonia solution was added to the granular aluminum oxide particles containing gold and silver ions. Addition of ammonia reduced the gold and silver ions to oxides/hydroxides. The sample was washed with excess DI water. The washed granules were dried at 105° C. for a period of about 2 hours. The gold-silver oxides/hydroxide coated aluminum oxide granules were subsequently calcined for 4 hours at 425° C. in a Barstead Thermolyne 1300 muffle furnace. During the calcination process, the gold-silver oxide/hydroxide is converted to gold-silver nanocatalysts.

Gamma phase aluminum oxide granules were purchased from Fisher Scientific. All other chemicals used in the experiment were purchased from Sigma Aldrich Chemicals. The chemicals were used without further purification. The granules were milled and sieved to collect −18+30 US mesh size particles. The aluminum oxide was washed to remove the fines and dried at 105° C. over a period of about 16 hours to ensure complete removal of moisture. This aluminum oxide was used as support for the catalyst.

The foregoing is illustrative of the present invention, and is not to be construed as limiting thereof. The invention is defined by the following claims, with equivalents of the claims to be included therein.

That which is claimed is:

1. A catalyst comprising similar proportions of gold and silver on a granular support.

2. The catalyst of claim 1, wherein the granular support comprises a metal oxide.

3. The catalyst of claim 1, wherein the granular support comprises aluminum oxide.

4. The catalyst of claim 1, wherein the particle size of the catalyst is less than about 10 nm.

5. A process for the synthesis of a gold-silver catalyst, the process comprising:
(a) adding a granular substrate to a mixture of gold salt with a solution of a silver salt;
(b) adjusting the pH;
(c) washing the product remaining after (b) with deionized water; and
(d) calcining the product resulting from to provide a gold-silver catalyst.

6. The process of claim 5, wherein the granular substrate is a metal oxide.

7. The process of claim 5, wherein the granular substrate is aluminum oxide.

8. The process of claim 5, wherein the pH is adjusted to about 4.0.

9. The process of claim 5, wherein the catalyst is a nanocatalyst.

10. The process of claim 9, wherein the particle size of the catalyst is less than about 10 nm.

11. The process of claim 5, wherein the catalyst comprises a similar proportion of gold and silver.

12. The process of claim 5, wherein the catalyst comprises less than about 10% more gold than silver.

13. A process for the oxidation of carbon monoxide at a room temperature comprising introducing a catalyst having a similar proportion of gold and silver to an environment having carbon monoxide under conditions suitable to support the substantial conversion of carbon monoxide to carbon dioxide at a room temperature.

14. The process of claim 13, wherein the catalyst is a nanocatalyst.

15. The process of claim 14, wherein the particle size of the catalyst is less than about 10 nm.

16. The process of claim 13, wherein the catalyst is present on a granular support.

17. The process of claim 16, wherein the granular support comprises a metal oxide.
